(19) United States
(12) Patent Application Publication
(10) Pub. No.: US 2026/0339141 A1
(43) Pub. Date: Oct. 29, 2026

(54) Display Device and Driving Method Thereof

(71) Applicant: LG Display Co., Ltd., Seoul (KR)

(72) Inventors: Seung Taek Oh, Paju-si (KR); Bo Gun Seo, Paju-si (KR)

(21) Appl. No.: 19/572,683

(22) Filed: Mar. 19, 2026

(30) Foreign Application Priority Data
Apr. 29, 2025 (KR) 10-2025-0056382

(51) Int. Cl. G02F 1/1333; G02F 1/13357; G09G 3/36

(52) U.S. Cl. CPC G02F 1/13338; G02F 1/133615; G09G 3/3648; G09G 2360/14

(57) ABSTRACT

A display device and a driving method thereof are disclosed. The display device includes a display panel including an active area including a first area and a second area with different subpixel arrangement densities, and a non-active area disposed outside the active area, and an optical module including a prism disposed under the display panel. The prism includes a first surface parallel to a lower surface of the first area of the display panel and a second surface perpendicular to the first surface. The optical module further includes a sensor reflective plate disposed at the second surface of the prism. The sensor reflective plate includes, in a region thereof, a pattern portion having a plurality of spaced reflective patterns. The optical module also includes a sensor member configured to receive external light through the pattern portion of the sensor reflective plate.

### CROSS REFERENCE TO RELATED APPLICATION

This application claims the priority benefit of Republic of Korea Patent Application No. 10-2025-0056382, filed on Apr. 29, 2025, which is hereby incorporated by reference as if fully set forth herein.

### TECHNICAL FIELD

The present disclosure relates to a device and particularly to, for example, without limitation, a display device including an optical module configured to perform a sensing function and a driving method thereof.

A display device displays images.

Such a display device includes a display panel and may display an image through the display panel.

The display panel may be classified into a self-luminous display panel configured to directly generate light to display an image, and a non-self-luminous display panel configured to display an image by receiving light from an external source.

For example, in the case of a display device including a non-self-luminous display panel, a light source unit may be disposed under the display panel to deliver light to the display panel, and the display panel may emit an image to the outside using the delivered light.

Recently, in addition to their inherent function of displaying an image, display devices are required to sense external light, and research is being conducted on arrangement of a configuration for sensing external light without interfering with components of such a display device.

Accordingly, the present disclosure is directed to a display device and a driving method thereof that substantially obviate one or more problems due to limitations and disadvantages of the related art.

An aspect of a display device of the present disclosure is to include an optical module overlapping with an active area without increasing a non-active (bezel) area of a display panel.

Another aspect of the display device of the present disclosure is to include a display panel and a backlight unit modified in accordance with the provision of an optical module for sensing external light and to reduce an image quality difference between an area overlapping with the optical module and an area not overlapping with the optical module in the active area.

Another aspect of the display device of the present disclosure is to increase light emission in an area corresponding to a sensing area of the optical module in order to prevent or reduce the sensing area from being visible.

Aspects of the present disclosure are not limited to the above-described aspect, and other aspects of the present disclosure not yet described will be more clearly understood by those skilled in the art from the following description.

In an aspect of the present disclosure, a display device includes a display panel including an active area including a first area and a second area with different subpixel arrangement densities, and a non-active area disposed outside the active area, and an optical module including a prism disposed under the display panel, the prism including a first surface parallel to a lower surface of the first area of the display panel and a second surface perpendicular to the first surface, a sensor reflective plate disposed at the second surface of the prism, the sensor reflective plate including, in a region thereof, a pattern portion having a plurality of spaced reflective patterns, and a sensor member configured to receive external light through the pattern portion of the sensor reflective plate.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with embodiments of the disclosure.

### BRIEF DESCRIPTION OF THE DRAWINGS

The accompanying drawings, which are included to provide a further understanding of the disclosure and are incorporated in and constitute a part of this application, illustrate embodiments of the disclosure and along with the description serve to explain the principle of the disclosure. In the drawings:

FIG. 1 is a plan view of a display device according to an embodiment of the present disclosure;

FIG. 2 is a cross-sectional view taken along line I–I′ of FIG. 1 according to an embodiment of the present disclosure;

FIG. 3A is a plan view of an area B of FIG. 1 as seen from above the display device according to an embodiment of the present disclosure;

FIG. 3B is a cross-sectional view of the display device according to an embodiment for the area B of FIG. 1;

FIG. 4 is a perspective view of the display device for the area B of FIG. 1 according to an embodiment of the present disclosure;

FIG. 5 is a plan view showing a display panel in an area C of FIG. 4 according to an embodiment of the present disclosure;

FIGS. 6A and 6B are cross-sectional views taken along lines II–II′ and III–III′ in FIG. 5, respectively according to an embodiment of the present disclosure;

FIG. 7 is a perspective view showing a backlight unit of FIG. 4 according to an embodiment of the present disclosure;

FIG. 8 is a cross-sectional view showing an embodiment of the backlight unit of FIG. 7 according to an embodiment of the present disclosure;

FIG. 9 is a perspective view of an optical module of FIG. 4 and a view showing an embodiment of a sensor reflective plate provided at a second surface of a prism according to an embodiment of the present disclosure;

FIG. 10 is a view showing areas of the optical module and the display panel that correspond one-to-one in accordance with an embodiment of the present disclosure;

FIG. 11 is a diagram showing the display panel in an area D of FIG. 3A in the display mode according to an embodiment of the present disclosure;

FIG. 12 is a diagram illustrating a wiring layout of the display panel in the area D of FIG. 3A in accordance with an embodiment of the present disclosure; and

FIG. 13 is a timing diagram of a display device according to an embodiment of the present disclosure.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION OF THE DISCLOSURE

Reference will now be made in detail to embodiments of the present disclosure, examples of which may be illustrated in the accompanying drawings. In the following description, when a detailed description of well-known functions or configurations related to this document is determined to unnecessarily cloud a gist of the inventive concept, the detailed description thereof will be omitted or may be briefly discussed. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations may be selected only for convenience of writing the specification and may be thus different from those used in actual products.

Advantages and features of the present disclosure, and a method of achieving the advantages and features will become apparent with reference to the example embodiments described herein in detail together with the accompanying drawings. The present disclosure should not be construed as limited to the example embodiments as disclosed below, and can be embodied in various different forms. Thus, these example embodiments are set forth only to make the present disclosure sufficiently complete, and to assist those skilled in the art to fully understand the scope of the present disclosure. The protected scope of the present disclosure is defined by the claims and their equivalents.

In the following description of the present disclosure, where the detailed description of the relevant known steps, elements, functions, technologies, and configurations can unnecessarily obscure an important point of the present disclosure, a detailed description of such steps, elements, functions, technologies, and configurations maybe omitted. In addition, the names of elements used in the following description are selected in consideration of clarity of description of the specification, and can differ from the names of elements of actual products. Furthermore, in the following detailed description of the present disclosure, numerous specific details are set forth in order to provide a sufficiently thorough understanding of the present disclosure. However, it will be understood that the present disclosure can be practiced without these specific details. In other instances, known methods, procedures, components, and circuits have not been described in detail so as not to unnecessarily obscure aspects of the present disclosure.

The shapes, sizes, ratios, angles, numbers, and the like, which are illustrated in the drawings to describe various example embodiments of the present disclosure are merely given by way of example. The disclosure is not limited to the illustrations in the drawings.

In the present specification, where terms such as “including,” “having,” “comprising,” and the like are used, one or more components can be added, unless the term, such as “only,” is used. As used herein, the term “and/or” includes a single associated listed item and any and all of the combinations of two or more of the associated listed items.

Any implementation described herein as an “example” is not necessarily to be construed as preferred or advantageous over other implementations.

An expression such as “at least one of” when preceding a list of elements can modify the entire list of elements and may not modify the individual elements of the list. The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, and the third element.

The terminology used herein is to describe particular aspects and is not intended to limit the present disclosure. As used herein, the terms “a” and “an” used to describe an element in the singular form is intended to include a plurality of elements. An element described in the singular form is intended to include a plurality of elements, and vice versa, unless the context clearly indicates otherwise.

In construing a component or numerical value, the component or the numerical value is to be construed as including an error or tolerance range even where no explicit description of such an error or tolerance range is provided.

In describing the various example embodiments of the present disclosure, where the positional relationship between two elements is described using terms, such as “on”, “above”, “under” and “next to”, at least one intervening element can be present between the two elements, unless “immediate(ly)” or “direct(ly)” or “close(ly) is used. It will be understood that when an element or layer is referred to as being “connected to”, or “coupled to” another element or layer, it can be directly connected to or coupled to the other element or layer, or one or more intervening elements or layers can be present.

In describing the various example embodiments of the present disclosure, when terms such as “after,” “subsequently,” “next,” and “before,” are used to describe the temporal relationship between two events, another event can occur therebetween, unless a more limiting term, such as “just,” “immediate(ly),” or “directly” is used.

In describing the various example embodiments of the present disclosure, terms such as “first” and “second” can be used to describe a variety of components. These terms aim to distinguish the same or similar components from one another and do not limit the components. Accordingly, throughout the specification, a “first” component can be the same as a “second” component within the technical concept of the present disclosure, unless specifically mentioned otherwise.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning, for example, consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

Rather, these embodiments may be provided so that this disclosure may be sufficiently thorough and complete to assist those skilled in the art to fully understand the scope of the present disclosure. Furthermore, the present disclosure is only defined by scopes of claims.

Features of various embodiments of the present disclosure can be partially or overall coupled to or combined with each other, and can be variously inter-operated with each other and driven technically as those skilled in the art can sufficiently understand. The embodiments of the present disclosure can be carried out independently from each other, or can be carried out together in a co-dependent relationship.

Hereinafter, preferred embodiments of the present disclosure will be described in detail with reference to the accompanying drawings. In adding reference numerals to elements of each of the drawings, although the same elements are illustrated in other drawings, like reference numerals can refer to like elements.

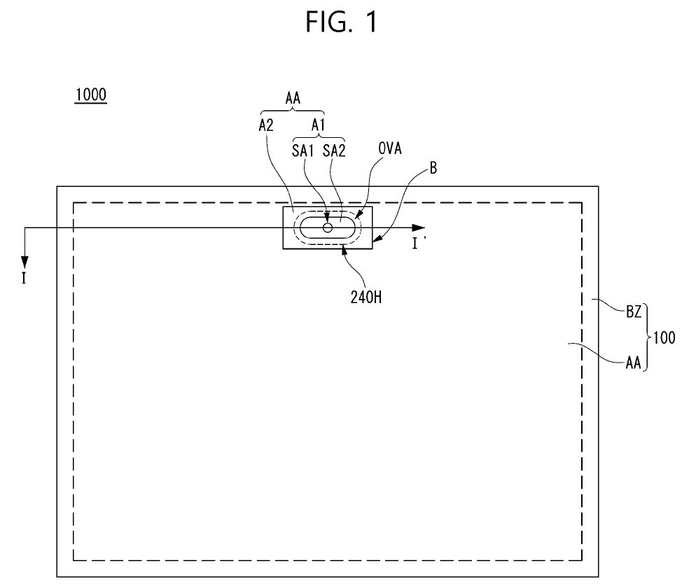

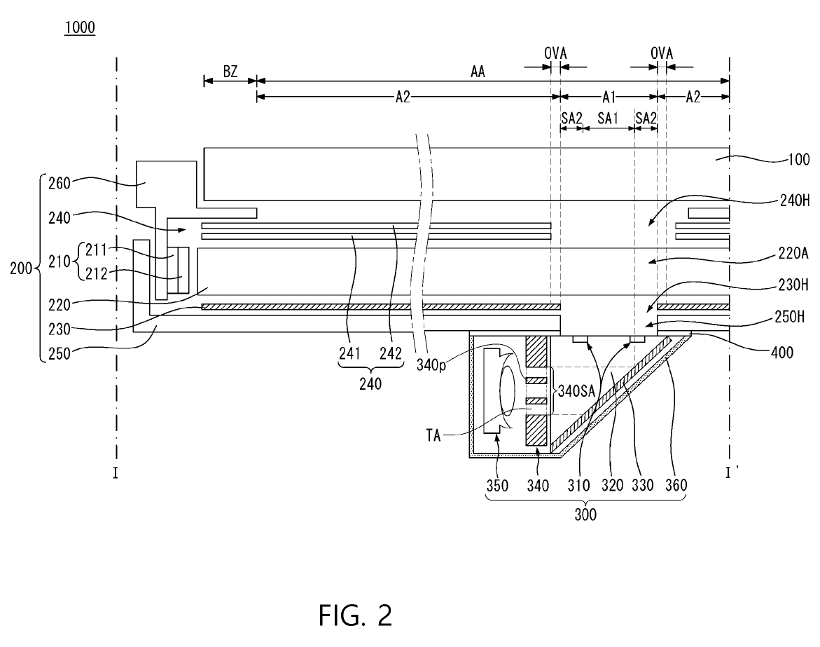

FIG. 1 is a plan view of a display device according to an embodiment of the present disclosure. FIG. 2 is a cross-sectional view taken along line I–I′ of FIG. 1.

As shown in FIGS. 1 and 2, a display device 1000 according to an embodiment of the present disclosure may include a display panel 100, a backlight unit 200, and an optical module 300.

The display panel 100 includes an active area (a display area) AA including a first area A1 and a second area A2 with different subpixel arrangement densities, and a non-active area (a non-display area) BZ disposed outside the active area AA. The display panel 100 displays an image to a viewer through the active area AA. The non-active area BZ is also referred to as a “bezel area” in that a housing structure such as a cover bottom or a middle frame is coupled thereto.

The first area A1 of the display panel 100 may be an area having a low resolution, and the second area A2 may be an area having a normal resolution.

Meanwhile, the normal resolution and the low resolution may be determined based on the arrangement density of subpixels. Subpixels may be defined by intersection regions of gate lines and data lines. In the normal-resolution area, the gate lines and the data lines are spaced at regular intervals such that the subpixels are regularly disposed. For example, in the normal-resolution area, red, green, and blue subpixels may be disposed with a uniform width and a uniform length.

The low-resolution area includes an area in which a part of the gate lines and/or a part of the data lines are disposed adjacent to one another such that no subpixel is formed between the adjacent gate lines and/or the adjacent data lines. The low-resolution area may include an area where no subpixel is formed between the gate lines and the data lines. Shapes of the normal-resolution area and the low-resolution area of the display panel 100 will be described later in detail with reference to the drawings.

In the low-resolution first area A1, external light may pass through the display panel 100 via a subpixel non-formation area and, as such, transmittance of the external light may be enhanced. The subpixel non-formation area is an area where at least one of light-absorbing components such as the gate lines, the data lines, color filters, etc. is omitted. Even in the low-resolution first area A1, display is possible through subpixels other than the subpixel non-formation area and, as such, may be used as an active area.

Subpixels may also be disposed in the first area A1 overlapping with the optical module 300 configured to sense external light. In this regard, display may be performed even in the area overlapping with the optical module 300. Accordingly, in the display device of each embodiment of the present disclosure, the effective active area is not reduced due to disposition of the optical module 300.

The illustrated display device 1000 includes the display panel 100, which is non-self-luminous. For this reason, the display device 1000 also includes the backlight unit 200 which is configured to deliver light to the display panel 100. When the display panel 100 is a self-luminous display panel, the backlight unit 200 may be omitted in some cases.

An example of a non-self-luminous display panel used as the display panel 100 may be a liquid crystal panel.

The backlight unit 200 is configured to deliver light toward the display panel 100 and may include a light source element 210, a light guide plate 220 disposed under the display panel 100 and configured to have a size substantially corresponding to the size of the display panel 100, a reflective plate 230 configured to re-reflect light directed downwards from the light guide plate 220 such that the light is directed upwards, and an optical sheet 240 disposed between the light guide plate 220 and the display panel 100 and configured to diffuse light directed upwards from the light guide plate 220 and to deliver the diffused light toward the display panel 100.

In addition to the above-described components, the backlight unit 200 may further include a middle frame 260 on which the display panel 100 is seated, and a cover bottom 250 configured to accommodate the light guide plate 220, the reflective plate 230, and the light source element 210. A portion of the middle frame 260 may be received within the cover bottom 250.

An area where the middle frame 260 overlaps with the display panel 100 is a non-active area BZ, and the display panel 100 may further include, in the non-active area BZ, configurations of a pad portion and a circuit film and/or a circuit board connected to the pad portion. The middle frame 260 and the cover bottom 250 may function to accommodate configurations disposed therein and to prevent or reduce movement of the configurations, and may further include configurations of a seating surface and/or a stepped portion in some areas. For example, the middle frame 260 may further include a seating surface protruding toward the display panel 100 in an area where the display panel 100 is seated.

The circuit film and the circuit board connected or coupled to the display panel 100 may be disposed in a state of being folded under the display panel 100.

The light source element 210 may be disposed to emit light toward one side surface of the light guide plate 220. As shown in FIG. 2, the light source element 210 may include a circuit board 211 and a light source 212. The light source 212 is a self-luminous element configured to generate light and to emit the generated light. For example, the light source 212 may include an inorganic light-emitting element using an inorganic semiconductor as an emission medium, an organic light-emitting element using an organic semiconductor material as an emission medium, or a hybrid light-emitting element using a mixture of inorganic and organic materials as an emission medium. The light source 212 may be electrically connected to the circuit board 211 to perform on/off operation.

As shown in FIG. 2, the light source element 210 may be attached to the middle frame 260 or may contact the light guide plate 220. In a display device of another embodiment, the middle frame 260 is not inserted between the light guide plate 220 and the cover bottom 250, and the light source element 210 may directly contact the cover bottom 250.

The light guide plate 220 receives light from the light source 212 disposed at one side thereof and uniformly delivers the light in a horizontal direction. The light guide plate 220 upwardly delivers light re-introduced thereinto from the lower reflective plate 230 together with the horizontally-delivered light.

The reflective plate 230 may be disposed in a state of being attached to the light guide plate 220 or the cover bottom 250.

In FIG. 2, the optical sheet 240 is configured through inclusion of a first optical sheet 241 and a second optical sheet 242. This is merely an example, and the number or type of optical sheets may vary.

The optical sheet 240 may diffuse light transmitted from a lower side thereof to upwardly deliver the diffused light.

Meanwhile, the optical module 300 is a configuration separate from the configuration of the backlight unit 200 and is configured to sense external light. The optical module 300 may be disposed under the backlight unit 200.

The optical module 300 includes a prism 320 having a first surface parallel to a lower surface of the first area A1 of the display panel 100 and a second surface perpendicular to the first surface, a sensor reflective plate 340 disposed at the second surface of the prism 320 and including, in a region thereof, a pattern portion 340SA having a plurality of spaced reflective patterns, and a sensor member 350 configured to receive external light through the pattern portion 340SA of the sensor reflective plate 340.

The sensor member 350 may include, for example, a camera or an infrared (IR) sensor. The camera may sense visible light, and the IR sensor may sense infrared light. In some cases, one of the camera and the IR sensor may output a specific image based on sensed information.

In an example, the sensor member 350 may include a lens portion at a side thereof facing the pattern portion 340SA, and a mold portion disposed under the lens portion and configured to accommodate the lens portion. The sensor member 350 may also include a sensor circuit board disposed within the mold portion and configured to sense and analyze external light.

The prism 320 of the optical module 300 may be disposed to have a shape of, for example, a triangular pillar. The drawing observed in FIG. 2 shows a triangular cross-section of the triangular prism 320. An inclined opposite surface is disposed between the first and second surfaces perpendicular to each other, and an opposite reflective plate 330 is disposed at the inclined opposite surface to refract light vertically incident into the prism 320 in a horizontal direction such that the refracted light is directed toward the sensor member 350.

The optical module 300 may further include an auxiliary light source 310 configured to deliver light to the first area A1 of the display panel 100. One or more auxiliary light sources 310 may be provided. The auxiliary light source 310 may be attached to the prism 320. In the example shown in FIG. 2, two auxiliary light sources 310 are illustrated, but this is merely an example. Additional auxiliary light sources may be disposed at a surface other than the surface of the prism 320.

The optical module 300 may further include an optical module housing 360 configured to accommodate the prism 320, the auxiliary light source 310, the sensor reflective plate 340, the opposite reflective plate 330, and the sensor member 350 described above.

The optical module housing 360 may be attached to a lower side of the cover bottom 250 via a fixing tape 400.

Meanwhile, in the optical module 300, the first surface of the prism 320 may be exposed from the backlight unit 200 to facilitate transmission of external light for at least the first area A1. To this end, the cover bottom 250, the reflective plate 230, and the optical sheet 240 may respectively include a cover bottom hole 250H, a reflective plate hole 230H, and an optical sheet hole 240H.

In the backlight unit 200, the light guide plate 220 may be thicker than the optical sheet 240 or the reflective plate 230. Among the components of the backlight unit 200, the optical sheet 240, which is spaced apart from the first surface of the prism 320 by a relatively great vertical distance, may have, in a region corresponding to the prism 320, the optical sheet hole 240H that is larger than the reflective plate hole 230H and the cover bottom hole 250H of the reflective plate 230 and the cover bottom 250, which are disposed relatively closer to the prism 320.

The reflective plate hole 230H and the cover bottom hole 250H may have a shape substantially corresponding to the shape of the first area A1 of the display panel 100. The optical sheet hole 240H has a slightly larger size than the first area A1. External light downwardly introduced from above the display panel 100 into the reflective plate hole 230H and the cover bottom hole 250H may include, in addition to direct light vertically incident through the first area A1, some light incident from a side surface of the first area A1. The light may be introduced into the prism 320 of the optical module 300 through the optical sheet hole 240H.

The reflective plate 230 and the cover bottom 250 may extend into a part of the interior of the optical sheet 240, that is, the optical sheet hole 240H, to form an overlapping area OVA. In the display panel 100, the area corresponding to the overlapping area OVA may be the second area A2 having a normal resolution.

The boundary between the first area A1 and the second area A2 may be an area corresponding to the reflective plate hole 230H of the reflective plate 230.

Among the components of the backlight unit 200, the light guide plate 220 may include diffusion patterns at upper and lower surfaces thereof. However, in an area 220A of the light guide plate 220 corresponding to the first area A1 of the display panel 100, the diffusion patterns of the upper and lower surfaces may be omitted to allow external light transmission.

The optical module 300 senses the amount of external light, an image, etc. received from above the display panel 100. To enhance the external-light sensitivity of the optical module 300, the display panel 100 and the backlight unit 200 may have, in the first area A1 overlapping with the optical module 300, a configuration different from that of the second area A2.

External light passes through the display panel 100 and the backlight unit 200, is refracted by the prism 320 of the optical module 300 disposed under the display panel 100, and is received by the sensor member 350 through a transmission portion provided at the pattern portion 340SA of the sensor reflective plate 340.

The sensor reflective plate 340 may be disposed in a state of being attached to the prism 320. In the sensor reflective plate 340, a reflective material is disposed in a region other than the pattern portion 340SA, and a plurality of spaced reflective patterns is included in the pattern portion 340SA. The plurality of spaced reflective patterns may be disposed to correspond to the shape of subpixels disposed in a first sub-area SA1 at the center of the first area A1 of the display panel 100. The sensor member 350 may sense external light through the transmission portion provided at the pattern portion 340SA of the sensor reflective plate 340. The reflective patterns in the pattern portion 340SA of the sensor reflective plate 340 and the reflective material outside the pattern portion 340SA may be directly formed on the second surface of the prism 320. In another embodiment, the sensor reflective plate 340 may be formed by depositing the reflective patterns and the reflective material on a base substrate, and attaching the base substrate to the prism 320.

In the display panel 100, the first area A1 is an area having a low resolution and overlapping with the optical module 300. More specifically, the first area A1 may overlap with at least a portion of the first surface of the prism 320, which is parallel to a horizontal plane of the display panel 100, among the components of the optical module 300. The reflective plate hole 230H may be provided at a position overlapping with the first area A1 so that the reflective plate hole 230H overlaps with the first surface of the prism 320 exposed from the reflective plate 230 to be fully utilized as a light transmission path. Accordingly, external light passes through the display panel 100, the optical sheet hole 240H of the backlight unit 200, the area 220A of the light guide plate 220 where no diffusion pattern is disposed, and the reflective plate hole 230H, and is then transmitted to the prism 320. As a result, the transmittance of the external light is increased. That is, in the light path along which external light is transmitted, the first area A1 of the display panel 100 is configured to have a low resolution such that wirings of the gate lines and the data lines and/or structures of color filters and a black matrix, which cause light absorption, are not disposed in the first area A1, allowing external light to travel at a high transmittance. In addition, the optical sheet hole 240H and the reflective plate hole 230H, which do not have any medium in the external light transmission path, may transmit light without loss of light quantity.

Meanwhile, the first area A1 may be divided into a first sub-area SA1 substantially corresponding to the area of the pattern portion 340SA of the sensor reflective plate 340 and a second sub-area SA2 disposed around the first sub-area SA1. The first sub-area SA1 corresponds to the area of the pattern portion 340SA of the sensor reflective plate 340 of the optical module 300, and the second sub-area SA2 corresponds to an area, in which a reflective material is disposed, around the pattern portion 340SA of the sensor reflective plate 340. The pattern portion 340SA of the sensor reflective plate 340 includes a plurality of reflective patterns and transmission portions among the plurality of reflective patterns. The plurality of reflective patterns may be arranged to have a shape corresponding to the shape of subpixels provided in the first sub-area SA1. Reception of external light by the sensor member 350 may be directly performed through the transmission portions provided at the pattern portion 340SA of the sensor reflective plate 340.

In the optical module 300, the sensor reflective plate 340 is disposed at the second surface of the prism 320, which is perpendicular to the horizontal plane of the display panel 100. When the sensor reflective plate 340 overlaps with the first area A1 of the display panel 100 in plan view, the size of the pattern portion 340SA of the sensor reflective plate 340 may correspond to the size of the first sub-area SA1 within the first area A1 of the display panel 100.

In addition, the individual reflective patterns in the pattern portion 340SA of the sensor reflective plate 340 may correspond to the subpixels provided in the first sub-area SA1 of the display panel 100. In regions where the subpixels are disposed, light-absorbing components such as color filters, gate lines, data lines, etc. are disposed, whereas regions in the pattern portion 340SA of the sensor reflective plate 340, which overlap with regions where light-absorbing components are not disposed, do not have reflective patterns, thereby ensuring light transmission through the pattern portion 340SA. Meanwhile, when the sensor reflective plate 340 overlaps with the display panel 100, the pattern portion 340SA of the sensor reflective plate 340 corresponds to the first sub-area SA1 at the center of the first area A1 of the display panel 100, and the area outside the pattern portion 340SA of the sensor reflective plate 340 corresponds to the second sub-area SA2 outside the first sub-area SA1 of the display panel 100.

The size of the sensor reflective plate 340 is equal to or larger than the first area A1.

During external-light sensing (a sensing mode), both the light source element 210 of the backlight unit 200 and the auxiliary light source 310 of the optical module 300 are turned off to prevent or reduce interference caused by light other than external light. In this case, external light incident from above the display panel 100 enters the prism 320 and is delivered to the sensor member 350 through the pattern portion 340SA of the sensor reflective plate 340. In this case, the subpixels provided in at least the first area A1 of the display panel 100 are set to a white state so as to maintain a light-transmitting state. When the display panel 100 is normally black, transistors of the subpixels provided in the first area A1 are turned on such that the subpixels are changed to the white state. When the display panel 100 is normally white, the transistors of the subpixels provided in the first area A1 are maintained in an off state to maintain the white state. External light passes through the display panel 100, the optical sheet hole 240H, the area 220A of the light guide plate 220, and the reflective plate hole 230H, and then enters the prism 320. Thereafter, the external light is refracted by the opposite reflective plate 330, and is delivered to the sensor member 350 after passing through the pattern portion 340SA of the sensor reflective plate 340. The pattern portion 340SA has reflective patterns, but these reflective patterns are configured to correspond to subpixels of the display panel that include light-absorbing members. Accordingly, the transmittance of light after passing through the sensor reflective plate 340 in external-light sensing is similar to that of a configuration in which reflective patterns 340p are not provided in the transmission portions (regions corresponding to the sensor member) of the sensor reflective plate.

In a display mode in which an image is displayed through the display panel 100, the auxiliary light source 310 of the optical module 300 is driven for the first area A1, and the light source element 210 of the backlight unit 200 is driven for the second area A2. Accordingly, light is supplied from below the display panel 100, and image data signals are supplied to respective subpixels of the display panel 100. Thus, an image is displayed.

In the display mode, the sensor reflective plate 340 may be visible in the light path of the prism 320 exposed through the reflective plate hole 230H in the first area A1 of the display panel 100. However, the sensor reflective plate 340 is provided with reflective patterns 340p at the pattern portion 340SA thereof. Accordingly, the difference in areal luminance between the first and second sub-areas SA1 and SA2 within the first area A1 is minimized or reduced by virtue of the reflective material outside the pattern portion 340SA of the sensor reflective plate 340 and the reflective patterns 340p of the sensor reflective plate 340 having the same reflection characteristics. Additionally, the subpixels of the first sub-area SA1 of the display panel 100, which corresponds to the pattern portion 340SA having transmission portions TA in the sensor reflective plate 340, may receive light of relatively higher luminance or a higher data voltage than those of the second sub-area SA2, through the auxiliary light source 310 of the optical module 300 disposed under the subpixels or through data signals supplied to the data lines provided at the subpixels.

Meanwhile, in an area overlapping with the first area A1, the backlight unit 200 lacks an optical sheet or a diffusion pattern. Therefore, in order to prevent or reduce the luminance in the first area A1 from being relatively lower than that in the second area A2 due to the absence of such a component of the backlight unit 200, the luminance of the auxiliary light source 310 may be adjusted to be higher than that of the light source element 210 of the backlight unit 200.

In the display device 1000 according to each embodiment of the present disclosure, the optical module 300 is disposed under the display panel 100 such that the optical module 300 overlaps with the active area AA, thereby enabling external-light sensing without reducing the active area AA. In addition, in the display device 1000, the effective area of the display device 1000 may be maximized or increased because the non-effective area, i.e., the non-active area BZ (bezel area), is not used for arrangement of the optical module 300.

Hereinafter, each configuration in the display device according to each embodiment of the present disclosure will be described in more detail.

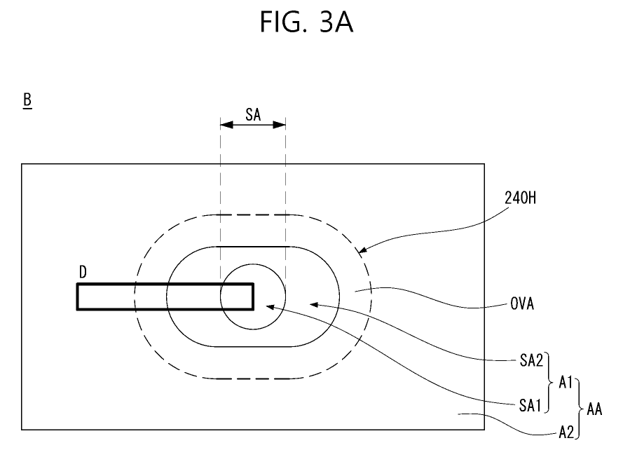

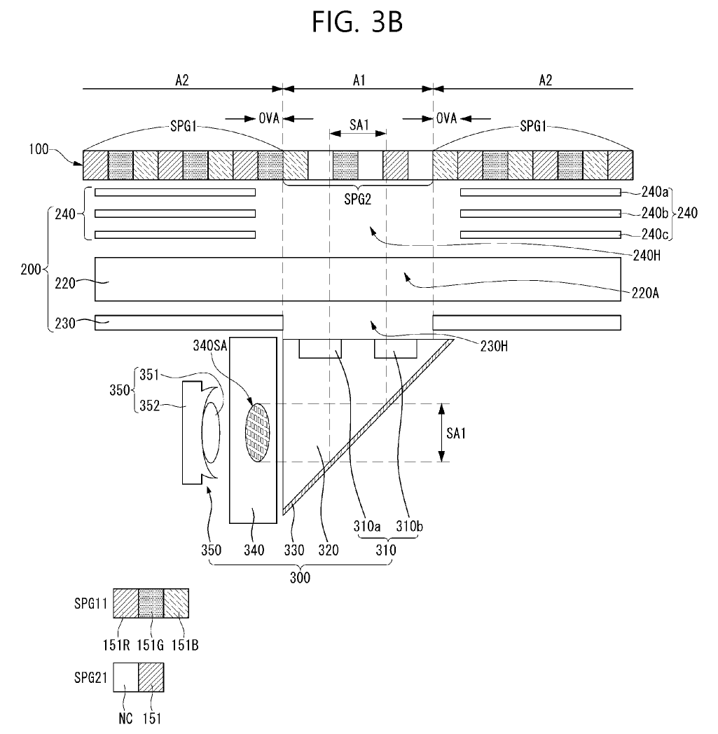

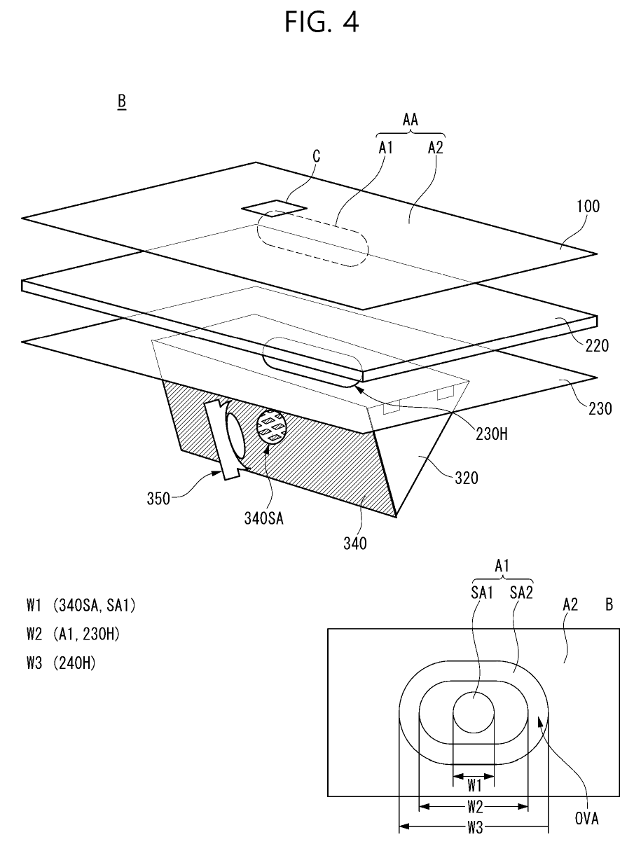

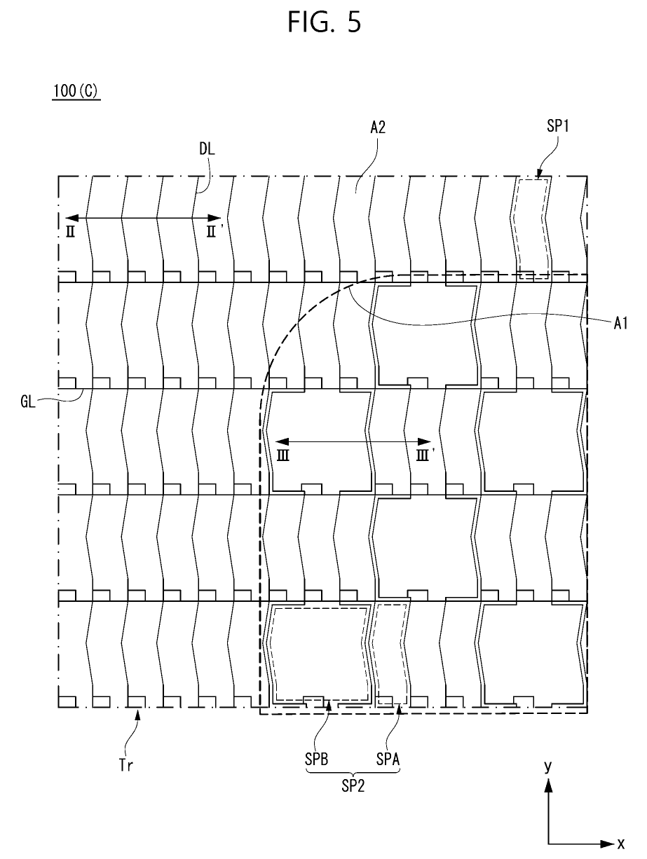

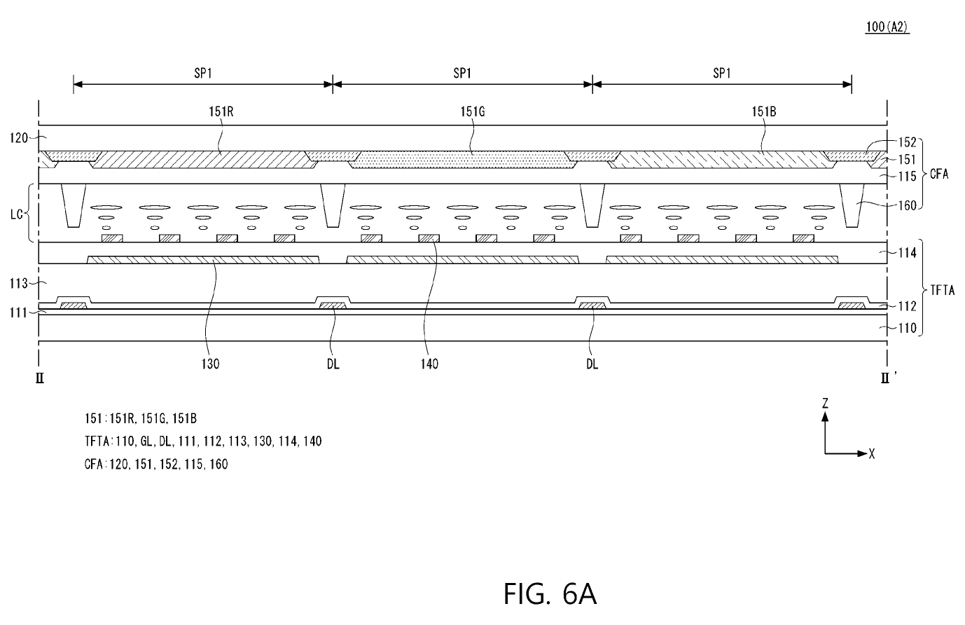

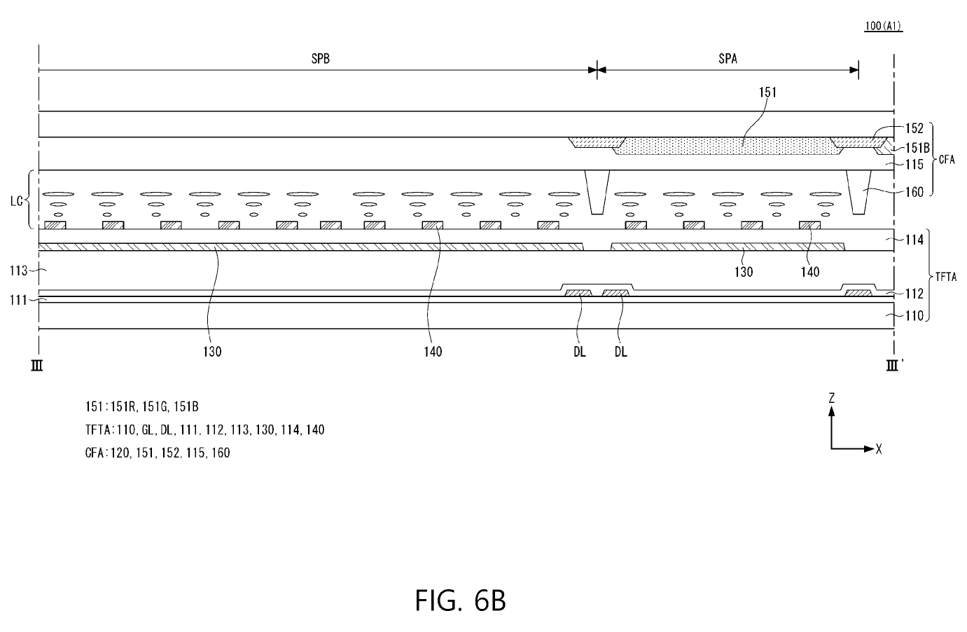

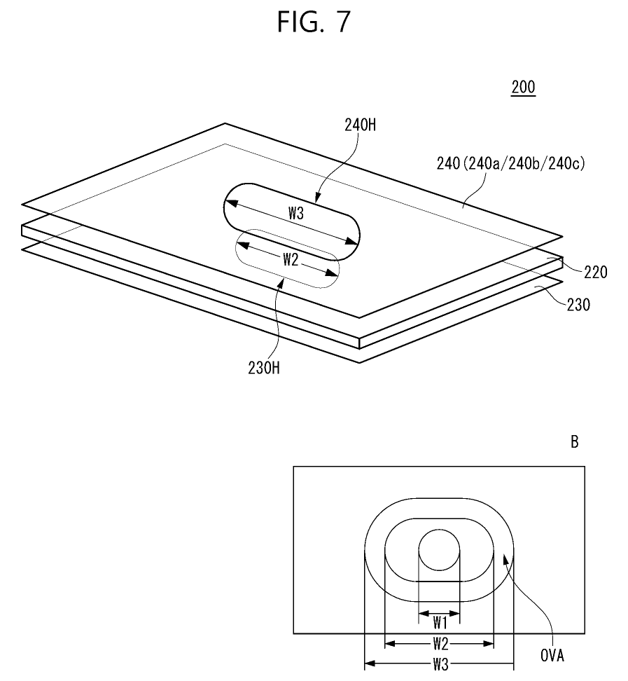

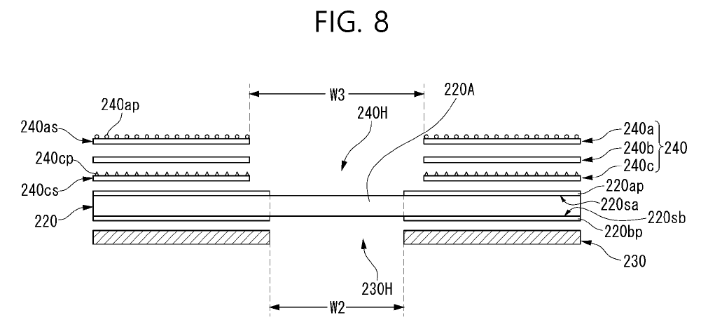

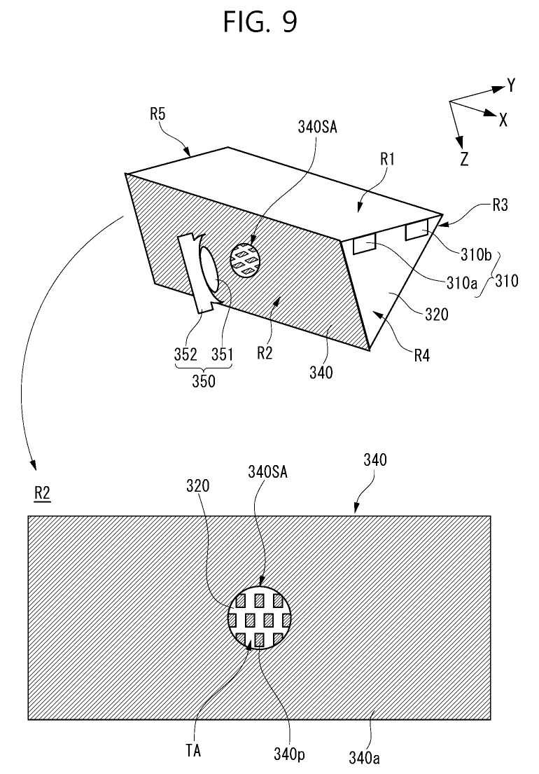

FIG. 3A is a plan view of an area B of FIG. 1 as seen from above the display device. FIG. 3B is a cross-sectional view of the display device according to an embodiment for the area B of FIG. 1. FIG. 4 is a perspective view of the display device for the area B of FIG. 1. FIG. 5 is a plan view showing a display panel in an area C of FIG. 4. FIGS. 6A and 6B are cross-sectional views taken along lines II–II′ and III–III′ in FIG. 5, respectively. FIG. 7 is a perspective view showing a backlight unit of FIG. 4. FIG. 8 is a cross-sectional view showing an embodiment of the backlight unit of FIG. 7. FIG. 9 is a perspective view of an optical module of FIG. 4 and a view showing an embodiment of a sensor reflective plate provided at a second surface of a prism.

FIG. 3A is an enlarged view of the first area A1 including first and second sub-areas and a portion of the second area A2 outside the first area A1 in an area of the display panel overlapping with the optical module 300.

As shown in FIGS. 3A and 3B, the first area A1 and the second area A2 differ in resolution. The second area A2, which overlaps the reflective plate 230, has a normal resolution, whereas the first area A1, which is exposed from the reflective plate 230 to enable sensing through the optical module 300, may have a low resolution to facilitate external light transmission. In the display panel 100, the second area A2 includes a first subpixel group SPG1 where subpixels are arranged in a regular array. In the display panel 100, the first area A1 may include a second subpixel group SPG2 where subpixels are arranged at a smaller arrangement density than that of the second area A2.

The first subpixel group SPG1 may include, for example, red, green, and blue subpixels capable of displaying red, green, and blue colors. As shown in FIG. 5, the first subpixel group SPG1 of the second area A2 may include first subpixels SP1 having a regular shape.

In an embodiment, the second subpixel group SPG2 may include, for example, a region NC where no color filter is disposed, in addition to red, green, and blue subpixels. The region NC where no color filter is disposed may function as a drivable white subpixel or may be an area in which no subpixel is disposed. In the first area A1, the region NC where no color filter is disposed may be used as a transmission portion TA in the second subpixel group SPG2 provided in the first area A1, during external-light sensing in the area overlapping with the optical module 300.

The red, green, blue, and white subpixels are provided with transistors, respectively, and may be individually turned on or off. The width or length of at least one of the red, green, blue, or white subpixels is greater than that of the other subpixels, and the subpixel arrangement density of the second subpixel group SPG2 may be smaller than that of the first subpixel group SPG1.

In the second subpixel group SPG2, for example, gate lines or data lines being densely arranged in addition to red, green, and blue subpixels. Thus, the second subpixel group SPG2 may include a region in which no subpixel is disposed, among the subpixels, as shown in FIG. 5.

As shown in FIG. 5, the second subpixels SP2 included in the second subpixel group SPG2 may be arranged such that color subpixels SPA capable of achieving color display and subpixels SPB representing a white state are mixed. The subpixels SPB representing a white state have no color filter and, as such, have high transmittance. In the first area A1, more subpixels SPB representing a white state are provided than in the second area A2 and are maintained in a white state during external-light sensing, thereby ensuring the transmittance of the first area A1. The subpixels SPB representing a white state may be white subpixels that may be turned on and off or regions in which wirings of gate lines and data lines and thin film transistors are omitted and no color filter pattern is provided.

Meanwhile, the reflective plate 230 may extend into a portion of the interior of the optical sheet hole 240H to have an overlapping area OVA. The display panel 100 overlapping with the overlapping area OVA is included in the second area A2 having a normal resolution. In some cases, the optical sheet 240 is not disposed in the second area A2, and therefore, in order to compensate for a luminance difference between the overlapping area OVA and the second area A2 disposed farther outward than the overlapping area OVA, the second area A2 may be divided into the overlapping area OVA and an area other than the overlapping area OVA to supply, to the different areas, different voltages to be applied to the data lines.

In the display panel 100 shown in FIG. 5, each data line DL has bent portions at vertical centers of the subpixels SP1 and SP2 corresponding thereto and is disposed to intersect the gate lines GL at an acute angle. This is, for example, to secure a viewing angle. In some cases, each of the subpixels SP1 and SP2a is provided with a plurality of bent portions.

The display panel 100 of FIGS. 6A and 6B illustrates, for example, an in-plane switching liquid crystal display panel.

As shown in FIGS. 6A and 6B, the display panel 100 may include a thin film transistor array substrate TFTA and a color filter array substrate CFA facing each other, and a liquid crystal layer LC.

As shown in FIGS. 5-6B, the thin film transistor array substrate TFTA may include a first substrate 110, gate lines GL and data lines DL crossing each other, thin film transistors Tr provided at intersections of the gate lines GL and the data lines DL, a gate insulating layer 111 disposed between the gate lines GL and the data lines DL, a first interlayer insulating layer 112 covering the data lines DL, a second interlayer insulating layer 113 protecting the thin film transistors Tr, a common electrode 130 disposed on the second interlayer insulating layer 113, a protective layer 114 covering the common electrode 130, and pixel electrodes 140 branched from respective subpixels on the protective layer 114.

Each thin film transistor Tr may include, for example, a gate electrode integrally formed with the gate line GL, an active layer overlapping with the gate electrode under the condition that a gate insulating layer 111 is interposed therebetween, and a source electrode and a drain electrode respectively connected to both sides of the active layer. The thin film transistor Tr may be connected to at least a portion of the pixel electrode 140 (not shown) in a corresponding one of the subpixels SP1 and SP2 to apply an electrical signal.

The common electrode 130 may be connected to a common voltage line.

Different voltages are applied to the common electrode 130 and the pixel electrode 140, respectively, to form a transverse electric field in each subpixel. FIGS. 6A and 6B illustrate an example in which the common electrode 130 is disposed under the protective layer 114 and the pixel electrode 140 is disposed above the protective layer 114. However, in some cases, the common electrode 130 may be disposed above the protective layer 114 and the pixel electrode 140 may be disposed under the protective layer 114.

The color filter array substrate CFA may include, for example, a second substrate 120, a black matrix 152 overlapping with the gate lines GL and the data lines DL, and color filters 151R, 151G, and 151B that represent predetermined colors in respective subpixels SP1 and SP2.

The color filters 151R, 151G, and 151B may include a red color filter 151R, a green color filter 151G, and a blue color filter 151B.

As shown in FIGS. 3B and 6B, the first area A1 having a low resolution includes the region NC in which no color filter is disposed on the second substrate 120. Through the region NC, external light may pass.

Meanwhile, as shown in FIG. 6B, the pixel electrode 140 and the common electrode 130 are disposed in at least a part of region NC in which no color filter is disposed. Accordingly, the part of the regions NC may function as a white subpixel which may be turned on and off in accordance with driving of the transistor Tr.

As shown in FIGS. 3B, 4, and 9, the pattern portion 340SA of the sensor reflective plate 340 of the optical module 300, which corresponds to the first sub-area SA1 within the first area A1 of the display panel 100, may have a transmission portion TA having an area corresponding to 1/2 or more of the total area of the pattern portion 340SA. This ensures sufficient reception of external light through the transmission portion TA of the pattern portion 340SA when external light is sensed by the sensor member 350 of the optical module 300.

The first sub-area SA1 of the first area A1 may have a first width W1, and the pattern portion 340SA of the sensor reflective plate 340 may have the same width as the first sub-area SA1, that is, the first width W1.

As shown in FIGS. 4 and 9, the pattern portion 340SA of the sensor reflective plate 340 may include a plurality of reflective patterns 340p having an island shape and corresponding to the color filters of the subpixels SP2 disposed in the first sub-area SA1 of the display panel 100. In some cases, the plurality of reflective patterns 340p may be arranged in accordance with the arrangement of a color filter group forming a unit.

As shown in FIGS. 3B, 4, 7, and 8, the backlight unit 200 disposed between the display panel 100 and the optical module 300 may include the optical sheet 240, the light guide plate 220, and the reflective plate 230, which are sequentially arranged from the side closer to the display panel 100 to the side farther from the display panel 100, and the light source element 210 disposed on at least one side of the light guide plate 220.

The optical sheet 240 may include the optical sheet hole 240H larger than the first area A1 of the display panel 100, and the reflective plate 230 may include the reflective plate hole 230H having a size corresponding to the size of the first area A1. The first area A1 has a second width W2, and the reflective plate hole 230H corresponding to the first area A1 may have the same second width W2.

To prevent or reduce interference when receiving external light, the optical sheet hole 240H of the optical sheet 240, which is formed to be wider than the reflective plate hole 230H, may have a third width W3.

The first width W1, the second width W2, and the third width W3 have greater sizes in this order.

FIG. 8 illustrates an example of the backlight unit 200 corresponding to the area B of FIG. 1.

The reflective plate 230 is disposed under the light guide plate 220, and a plurality of optical sheets 240 (240a, 240b, and 240c) is disposed on the light guide plate 220. FIG. 8 shows an example in which the optical sheets 240 are arranged in three layers. However, the number of optical sheets 240 may be varied as needed.

For example, the optical sheets 240 may include a first substrate 240as, a first film 240a disposed on a surface of the first substrate 240as and including particles 240ap having a refractive index different from that of the first substrate 240as, a second film 240b, a second substrate 240cs, and a third film 240c disposed on a surface of the second substrate 240cs and including a plurality of prism patterns 240cp. At least one of the first to third films 240a, 240b, and 240c has a diffusion function and serves to transmit light delivered from below to above without loss.

The optical sheets 240 each have an optical sheet hole 240H having a diameter corresponding to the third width W3, and the reflective plate hole 230H has a diameter corresponding to the second width W2.

Both surfaces 220sa and 220sb of the light guide plate 220 may include prism patterns 220ap and 220bp, respectively, in an area not overlapping with the first area A1 of the display panel 100.

The reason why the reflective plate hole 230H, the optical sheet hole 240H, and the area 220A of the light guide plate 220, in which and the prism patterns are not disposed, are provided to correspond to the first area A1 is to ensure that light transmitted through the first area A1 is delivered to the optical module 300 in a vertical direction without distortion.

As shown in FIG. 9, in the display device 1000, the optical module 300 includes the prism 320 configured to adjust an optical path, the sensor member 350 disposed adjacent to the prism 320 and configured to receive external light, and the sensor reflective plate 340 disposed at one surface of the prism 320 adjacent to the sensor member 350. The sensor reflective plate 340 includes the pattern portion 340SA facing the sensor member 350. The pattern portion 340SA includes a plurality of spaced reflective patterns 340p corresponding to the subpixels SP2 disposed in a portion of the low-resolution area of the display panel 100, that is, the first sub-area SA1. By virtue of the reflective patterns 340p of the sensor reflective plate 340, the reflection path within the prism 320 is extended, thereby increasing the amount of sensing light ultimately entering the sensor member 350. Thus, sensing sensitivity may be enhanced.

The prism 320 of the optical module 300 may have the shape of a triangular pillar parallel to the display panel 100. The triangular-pillar-shaped prism 320 may include a first surface R1 parallel to the lower surface of the display panel 100, a second surface R2 contiguous with the first surface R1 and having a direction perpendicular to the first surface R1, a third surface R3 inclined from and contiguous with each of the first and second surfaces R1 and R2, and a fourth surface R4 and a fifth surface R5 facing each other and surrounded by the first, second, and third surfaces R1, R2, and R3.

The first surface R1 may have a larger area than the first area A1. External light introduced through the first area A1 may be incident upon the prism 320 in the vertical direction without loss.

The second surface R2, on which the sensor reflective plate 340 is disposed, may have a larger area than the first sub-area SA1 of the first area A1 of the display panel 100. This is to secure a refractive path between the reflective material 340a included in the sensor reflective plate 340 outside the pattern portion 340SA corresponding to the first sub-area SA1 and the opposite reflective plate 330 provided at the third surface R3 of the prism 320.

The sensor reflective plate 340 may be directly formed on the second surface R2 of the prism 320. The reflective patterns 340p having a patterned shape in the pattern portion 340SA and the reflective material 340a outside the pattern portion 340SA may be made of the same material. The reflective material 340a and the reflective patterns 340p have the same reflective properties, and the optical refraction effect between the reflective material 340a and the opposite reflective plate 330 in the prism 320 and the optical refraction effect between the reflective patterns 340p and the opposite reflective plate 330 may be equal or similar. Accordingly, when viewed from outside the display panel 100, the visibility difference between the first sub-area SA1 corresponding to the pattern portion 340SA and the second sub-area SA2 outside the first sub-area SA1 may be reduced or prevented.

Meanwhile, the second surface R2 of the prism 320 on which the sensor reflective plate 340 is disposed may be covered by the reflective plate 330 of the backlight unit 200. Accordingly, the sensor reflective plate 340 may overlap with the second area A2 to which the normal resolution of the display panel 100 is applied. The sensor reflective plate 340 is vertically disposed on the second surface R2 of the prism 320. The second surface R2 of the prism 320, the sensor reflective plate 340 outside the second surface R2, and the sensor member 350 are concealed by the reflective plate 30 of the backlight unit 200. Accordingly, these components are not directly visible in the second area A2.

In addition, the optical module 300 may further include the opposite reflective plate 330 disposed on the third surface R3 of the prism 320, and the auxiliary light source 310 disposed on at least one of the fourth surface R4 or the fifth surface R5.

The area of the display panel 100 overlapping with the optical module 300 does not overlap with the optical sheets 240 of the backlight unit 200 and, as such, the amount of light supplied through the backlight unit 200 may be small. To this end, in the display device of each embodiment of the present disclosure, the auxiliary light source 310, which supplies light, correspondingly to the first area SA1 of the display panel 100 overlapping with the optical module 300, may be further disposed on the fourth surface R4 of the prism 320 of the optical module 300, in addition to the backlight unit 200. In the display mode for displaying an image, the second area A2 of the display panel 100, which does not overlap with the reflective plate hole 330H, receives light from the light source of the backlight unit 200, and the first area A1 of the display panel 100, which overlaps with the reflective plate hole 330H, may receive light from the auxiliary light source 310 disposed on one side surface of the prism 320. Accordingly, a luminance difference between the first area A1, where the optical sheets 240 are not disposed, and the second area A2, where the optical sheets 240 are disposed, may be prevented or reduced.

The sensor reflective plate 340 is in contact with the second surface R2 of the prism 320. The second surface R2 of the prism 320 may be exposed in a region where the plurality of reflective patterns 340p is not provided within the pattern portion 340SA of the sensor reflective plate 340.

External light may pass through the display panel 100 and may be received by the sensor member 350 via vertical light directed toward the opposite reflective plate 330 and horizontal light directed from the opposite reflective plate 330 toward the pattern portion 340SA of the sensor reflective plate 340.

For example, the sensor member 350 may include a lens portion 351 at the side facing the pattern portion 340SA, and a mold portion 352 disposed under the lens portion 351 to accommodate the lens portion 351. The mold portion 352 may include a sensor circuit board configured to sense and analyze external light.

When external light is received by the sensor member 350, the external light may pass through the regions NC of the display panel 100 where subpixels and/or color filters are not disposed and may then be incident upon the prism 320. The light incident upon the prism 320 may travel in the horizontal direction after being refracted at the opposite reflective plate 330, and may then pass through regions where the plurality of reflective patterns 340p is not disposed within the pattern portion 340SA of the sensor reflective plate 340, i.e., the transmission portions TA.

As shown in FIG. 9, the sensor reflective plate 340 includes a first reflective material 340a around the pattern portion 340SA, and the plurality of reflective patterns 340p in the pattern portion 340SA may be the same as the first reflective material 340a.

The second area A2 of the display panel 100 may be an area of the active area AA having a normal resolution.

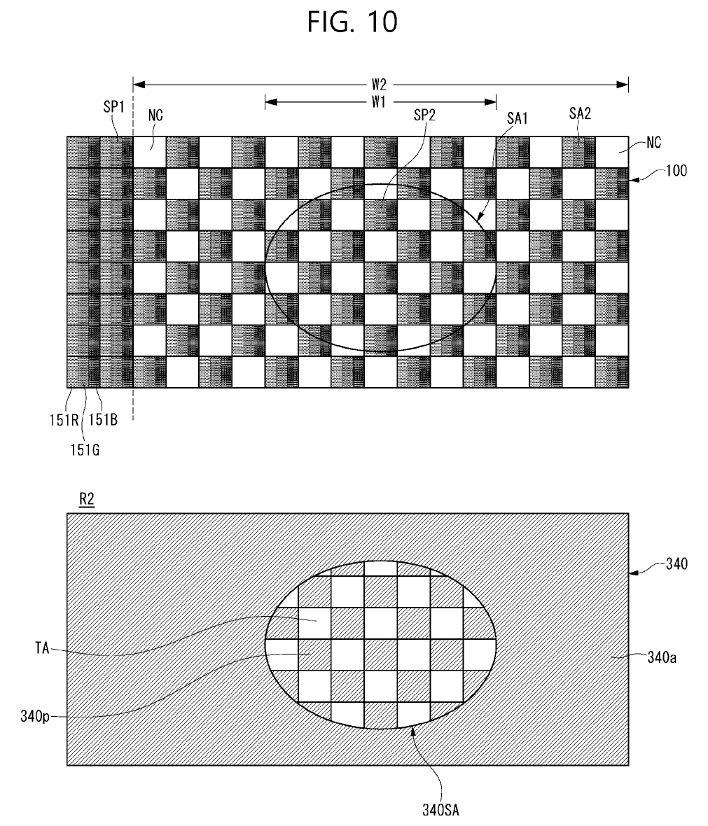

FIG. 10 is a view showing areas of the optical module and the display panel that correspond one-to-one in accordance with an embodiment of the present disclosure.

In the sensing mode for sensing external light, the sensor reflective plate 340 of the optical module may correspond to the first area A1 of the display panel 100. The low-resolution first area A1 may secure transmittance through regions where subpixels are not disposed or the regions NC where the color filters 151R, 151G, and 151B are not disposed. The first sub-area SA1 at the center of the first area A1 of the display panel 100 may correspond, one-to-one, to the pattern portion 340SA of the sensor reflective plate 340 and may have the same size as the pattern portion 340SA.

FIG. 10 illustrates an example in which, in the low-resolution first area A1 of the display panel 100, pixel units with red, green, and blue color filters 151R, 151G, and 151B arranged side by side are alternately disposed together with regions NC where color filters are not disposed.

Outside the first area A1, the second area A2 having a normal resolution is disposed. In the second area A2, pixel units with red, green, and blue color filters 151R, 151G, and 151B arranged side by side are regularly disposed. The color filters 151R, 151G, and 151B are disposed at respective first subpixels SP1 in the second area A2.

The first subpixels SP1 of the pixel units disposed in the second area A2 and the second subpixels SP2 of the pixel units disposed in the first area A1 may include the same red, green, and blue subpixels.

The pattern portion 340SA of the sensor reflective plate 340 may have the same size as the light-receiving area of the lens portion 351 of the sensor member 350 adjacent to the pattern portion 340SA.

The first area A1 of the display panel 100 may include a first sub-area SA1 having a size corresponding to the pattern portion 340SA of the sensor reflective plate 340, and a second sub-area SA2 surrounding the first sub-area SA1.

In the pattern portion 340SA of the sensor reflective plate 340, reflective patterns 340p are disposed to corresponds to the pixel units disposed in the first sub-area SA1 of the display panel 100. The pattern portion 340SA may have transmission portions TA corresponding to the regions NC where color filters are not disposed.

The reflective material 340a outside the pattern portion 340SA of the sensor reflective plate 340 includes the same reflective material as the reflective patterns 340p and has the same reflectance as the reflective patterns 340p. Accordingly, when a lower configuration is visible through the display panel 100, the pattern portion 340SA of the sensor reflective plate 340 and the reflective material 340a outside the pattern portion 340SA may appear with similar visual perception because the reflective patterns 340p within the pattern portion 340SA and the outside reflective material 340a have the same reflectance. Accordingly, it may be possible to reduce visual differences between corresponding regions in the first and second sub-areas SA1 and SA2.

In addition, the transmission portions TA of the sensor reflective plate 340 may transmit, to the sensor member 350, light refracted through the prism 320 during external-light sensing. In order to secure a sufficient transmittance, the area ratio of the transmission portions TA in the pattern portion 340SA may be larger than that of the reflective patterns 340p.

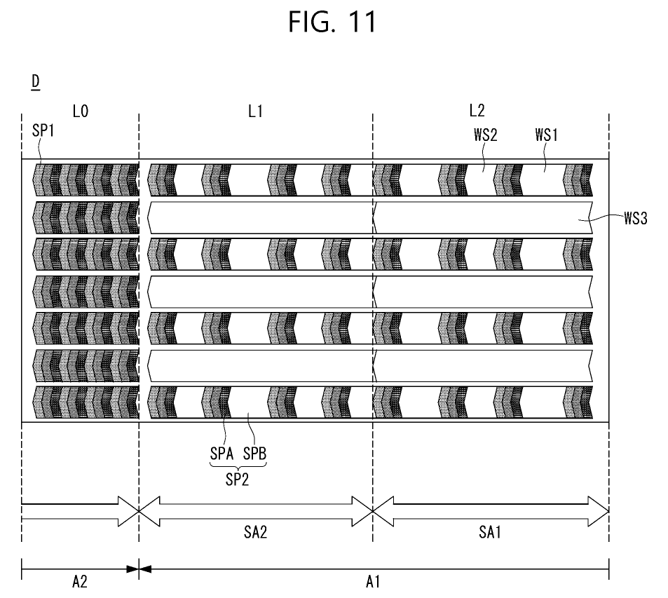

FIG. 11 is a diagram showing the display panel in an area D of FIG. 3A in the display mode according to an embodiment of the present disclosure.

As shown in FIG. 11, in the display mode for displaying an image through the display panel, the first area A1 overlapping with the reflective plate hole 230H and the optical sheet hole 240H may not receive sufficient light from the light source element 210 of the backlight unit 200. To this end, the first area A1 may receive light from the auxiliary light source 310 of the optical module 300.

As light from the auxiliary light source 310 is supplied to the first area A1, the first area A1 may receive light with luminances L1 and L2 different from the luminance L0 of light supplied to the normal-resolution second area A2, as compared to the second area A2.

In addition, the first area A1 includes the first sub-area SA1 directly corresponding to the pattern portion 340SA of the sensor reflective plate 340, and the second sub-area SA2 disposed outside the first sub-area SA1. The first and second sub-areas SA1 and SA2 may have the same arrangement of low-resolution subpixels. In the display mode, the first sub-area SA1 corresponding to the pattern portion 340SA may have a relatively higher luminance intensity than the second sub-area SA2 in order to prevent or reduce the sensor member 350 of the sensor reflective plate 340 from being visible. This may be achieved by adjusting light intensities of the first sub-area SA1 and the second sub-area SA2 to be different from each other by the auxiliary light source 310.

For example, FIG. 11 shows that the second subpixels SP2 of the first area A1 may each include color subpixels SPA at which red, green, and blue color filters are disposed, respectively, and a region SPB in which no color filter is disposed to represent a white state.

Regions SPB representing a white state may be white subpixels WS1, WS2, and WS3 drivable by thin film transistors Tr disposed on the thin film transistor array substrate TFTA or non-subpixel regions where neither wirings (gate lines and data lines) nor thin film transistors Tr are disposed.

As shown in FIG. 11, the white subpixels WS1, WS2, and WS3 may be disposed to have different widths. Depending on the sensing light amount required by the sensor member 350, the number and area of the white subpixels WS1, WS2, and WS3 may vary. In the example shown in FIG. 11, among the subpixels arranged from the top of the first area A1, all of the even-numbered subpixels are represented by white subpixels WS3, whereas the odd-numbered subpixels are represented by white subpixels WS1 and WS2 having different widths. This is merely one example, and, unlike the case of FIG. 11, the white subpixels WS1, WS2, and WS3 may also have the same size.

The luminance supplied to the first area A1 may be determined such that different luminance intensities are supplied to the first sub-area SA1 corresponding to the sensor member 350 and the pattern portion 340SA of the sensor reflective plate 340 and the second sub-area SA2 corresponding to the reflective material 340a outside the sensor member 350, respectively, due to differences in reflection paths generated within the prism 320. As different luminance intensities are supplied such that the second luminance L2 supplied to the first sub-area SA1 is higher than the first luminance L1 supplied to the second sub-area SA2, it may be possible to prevent or reduce the first sub-area SA1 from appearing dark due to a lack of the reflective material.

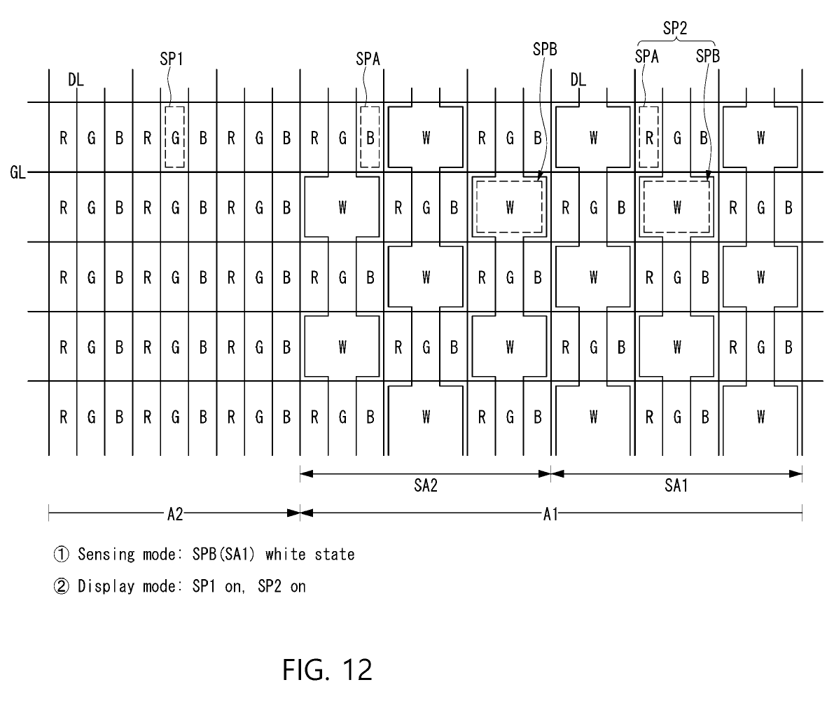

FIG. 12 is a diagram illustrating a wiring layout of the display panel in the area D of FIG. 3A in accordance with an embodiment of the present disclosure.

As shown in FIG. 12, in the display device according to the embodiment of the present disclosure, the wiring layout of the display panel may differ between the first area A1 having a low resolution and the second area A2 having a normal resolution.

The display panel includes, in an active area including a first area A1 and a second area A2, a plurality of gate lines GL and a plurality of data lines DL intersecting each other on a first substrate (cf. “110” in FIGS. 6A and 6B) to define subpixels.

The first area A1 includes a first sub-area SA1 having a size corresponding to the pattern portion 340SA of the sensor reflective plate 340, and a second sub-area SA2 surrounding the first sub-area SA1.

In the second area A2 of the display panel 100, for example, the plurality of data lines DL may be arranged at a uniform first pitch. When subpixels are defined at intersections of the gate lines GL and the data lines DL, first subpixels SP1 in the second area A2 may have the same size.

The first area A1 may include regions arranged at a second pitch greater than the first pitch of the plurality of data lines DL disposed in the second area A2. For example, in the first area A1, each second subpixel SP2 may include color subpixels SPA at which color filters of red (R), green (G), and blue (B) are disposed, respectively, and a white subpixel SPB at which no color filter is disposed. The white subpixel SPB may be provided with a transistor to enable on/off operation.

The display mode through the display panel and the external-light sensing mode through the optical module may be selectively performed.

In the display mode for displaying an image, the second subpixels SP2 of the first area A1 and the first subpixels SP1 of the second area A2 may be individually turned on or off to display an image.

The white subpixels SPB in at least the first sub-area SA1 of the first area A1 are maintained in a white state in the sensing mode for sensing external light in order to allow light transmission therethrough. In the external-light sensing mode, external light introduced from above the display panel 100 passes through the light guide plate 220 of the backlight unit 200 is incident upon the prism 320 as vertical light, is then refracted by the opposite reflective plate 330 toward the pattern portion 340SA of the sensor reflective plate 340, and, as such, may be sensed by the sensor member 350 through the pattern portion 340SA of the sensor reflective plate 340.

The data lines on both sides that define the white subpixel are disposed adjacent to the data lines for the red, green, and blue subpixels neighboring the data lines for the white subpixel. Accordingly, the white subpixel may have a relatively larger size than the red, green, and blue subpixels. The first area A1 may include not only color subpixels SPA including red (R), green (G), and blue (B) subpixels, but also white subpixels SPB.

In the case where each white subpixel W in the first area A1 is not provided with a transistor, the white subpixel W is maintained in a white state to enable light transmission.

In the case where the white subpixel W in the first area A1 is provided with a transistor, the white subpixel W has a white state in the external-light sensing mode to enable light transmission. For example, when the display panel 100 is normally black, the white subpixel W is turned on in accordance with supply of a pixel voltage through the transistor in the external-light sensing mode such that the white subpixel W is maintained in a white state. When the display panel 100 is normally white, the white subpixel W is maintained in an off state in the sensing mode to maintain the white state.

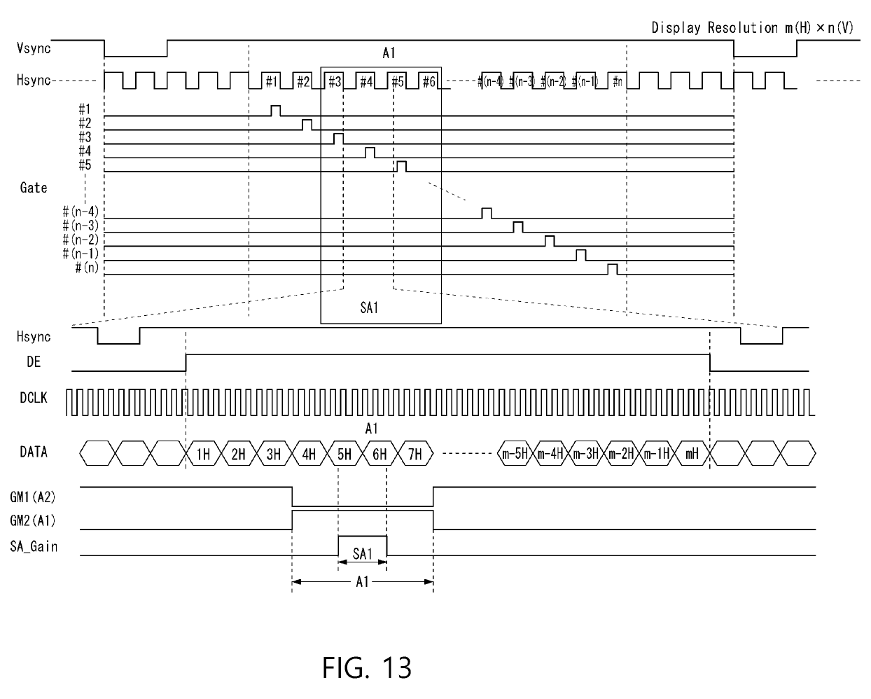

FIG. 13 is a timing diagram of a display device according to an embodiment of the present disclosure.

The display device shown in FIG. 13 includes a display panel having n gate lines and m data lines.

A vertical synchronization signal Vsync is supplied for each frame. In a high-level state of the vertical synchronization signal Vsync, gate signals are sequentially supplied to the first to n-th gate lines in accordance with a horizontal synchronization signal Hsync.

A data signal is supplied to the m data lines in accordance with a data clock signal DCLK in a high-level state of a data enable signal DE.

The data signal is supplied from a data driving IC. The data driving IC may include a gamma compensator configured to receive a digital image signal from a timing controller, to perform gamma compensation for the digital image signal, and to output the resultant signal as digital image data, and a data digital-to-analog converter configured to convert the digital image data delivered from the gamma compensator into analog data voltages to be supplied to the data lines.

In the embodiment of FIG. 13, the gamma compensator includes a first gamma unit configured to perform gamma compensation, correspondingly to the second area A2, and a second gamma unit configured to perform gamma compensation, correspondingly to the first area A1. The first and second gamma units perform gamma compensation for the second area A2 and the first area A1 when first and second gamma signals GM1 and GM2 are in a high-level state, respectively.

In the embodiment of FIG. 13, a gain signal SA_Gain is selectively supplied to the auxiliary light source 310 for the first sub-area SA1 in the first area A1. Accordingly, the second luminance (cf. “L2” in FIG. 11) of the first sub-area SA1 may be adjusted to be higher than the first luminance L1 of the second sub-area SA2.

In the display device according to the embodiment of the present disclosure, the first area A1 of the display panel overlapping with the optical module may be divided into the first sub-area SA1 corresponding to the pattern portion 340SA of a sensor reflective plate 340 and the second sub-area SA2 disposed outside the first sub-area SA1. In order to prevent or reduce subpixels in the first sub-area SA1 from appearing dark because the subpixels correspond to reflective patterns 340p within the sensor reflective plate or the sensor member 350, light having a higher luminance than that supplied to subpixels disposed in the second sub-area SA2 may be supplied to the subpixels disposed in the first sub-area SA1 in a display mode of the display device. Accordingly, it may be possible to prevent or reduce the first sub-area SA1 from appearing darker than the second sub-area SA2 during a display period.

The display device, according to each embodiment of the present disclosure, is driven in a display mode for displaying an image and a sensing mode for sensing external light. By controlling on/off of the auxiliary light source in the display mode and the sensing mode, it may be possible to prevent or reduce interference due to light other than external light in the sensing mode.

The display device according to each embodiment of the present disclosure may enhance visual perception and sensing sensitivity without addition of a separate configuration by changing the configuration and driving method of the pattern portion in the sensor reflective plate, and may have significance in sustainability through eco-friendly design, thereby achieving environmental/social/governance (ESG) goals.

The display device according to each embodiment of the present disclosure have the following effects.

First, in each embodiment of the present disclosure, the display device may sense external light without reduction of the active area by disposing the optical module under the display panel in a state of overlapping with the active area. In addition, the bezel area, which is a non-effective area, is not used for arrangement of the optical module. Accordingly, the effective area of the display device is maximized or increased.

Second, in the display device according to each embodiment of the present disclosure, the optical module includes a prism configured to adjust an optical path, a sensor member disposed adjacent to the prism and configured to receive external light, and a sensor reflective plate disposed at one surface of the prism adjacent to the sensor member. The sensor reflective plate includes a pattern portion facing the sensor member. The pattern portion includes a plurality of spaced reflective patterns corresponding to subpixels disposed in a portion of a low-resolution area of the display panel. By virtue of the reflective patterns of the sensor reflective plate, the reflection path within the prism is extended, thereby increasing the amount of sensing light ultimately entering the sensor member. Thus, sensing sensitivity may be enhanced.

Third, the area of the display panel overlapping with the optical module does not overlap with the optical sheet of the backlight unit and, as such, receives a smaller amount of light from the backlight unit. To this end, in addition to the backlight unit, an auxiliary light source, which is configured to supply light, correspondingly to a first area of the display panel overlapping with the optical module, is further disposed at one side surface of the prism of the optical module. In a display mode for displaying an image, a second area not overlapping with the optical module delivers light to the display panel via the light source of the backlight unit, and the first area overlapping with the optical module delivers light via the auxiliary light source disposed at one side surface of the prism. Accordingly, a luminance difference between the first area overlapping with the optical module and the second area not overlapping with the optical module may be prevented or reduced.

Fourth, the first area of the display panel overlapping with the optical module may be divided into a first sub-area corresponding to the pattern portion of the sensor reflective plate and a second sub-area disposed around the first sub-area. In order to prevent or reduce subpixels in the first sub-area from appearing dark because the subpixels correspond to the reflective patterns within the sensor reflective plate, light having a higher luminance than that supplied to subpixels disposed in the second sub-area may be supplied to the subpixels disposed in the first sub-area in a display period of the display device. Accordingly, it may be possible to prevent or reduce the first sub-area from appearing darker than the second sub-area during the display period.

Fifth, the display device according to each embodiment of the present disclosure is driven in a display mode for displaying an image and a sensing mode for sensing external light. By controlling on/off of the auxiliary light source in the display mode and the sensing mode, it may be possible to prevent or reduce interference of light other than external light in the sensing mode.

Sixth, the display device according to each embodiment of the present disclosure may enhance visual perception and sensing sensitivity without addition of a separate configuration by changing the configuration and driving method of the pattern portion in the sensor reflective plate, and may have significance in sustainability through eco-friendly design, thereby achieving environmental/social/governance (ESG) goals.

A display device according to one embodiment of the present disclosure may comprise a display panel comprising an active area comprising a first area and a second area with different subpixel arrangement densities, and a non-active area disposed outside the active area and an optical module.

The optical module may comprise a prism disposed under the display panel, the prism comprising a first surface parallel to a lower surface of the first area of the display panel and a second surface perpendicular to the first surface, a sensor reflective plate disposed at the second surface of the prism, the sensor reflective plate comprising, in a region thereof, a pattern portion having a plurality of reflective patterns spaced each other, and a sensor member configured to receive external light through the pattern portion of the sensor reflective plate.

In a display device according to one embodiment of the present disclosure, the pattern portion of the sensor reflective plate may have a transmission portion having an area corresponding to 1/2 or more of a total area of the pattern portion.

In a display device according to one embodiment of the present disclosure, the first area may have a smaller subpixel arrangement density than the second area in the display panel. The first area may comprise a first sub-area disposed at a center of the first area. The first sub-area may have a size corresponding to a size of the pattern portion of the sensor reflective plate, and a second sub-area surrounding the first sub-area and the pattern portion of the sensor reflective plate comprises a plurality of reflective patterns corresponding to color filters of subpixels disposed in the first sub-area of the display panel.

In a display device according to one embodiment of the present disclosure, subpixels of the second sub-area may have a higher luminance than the subpixels of the first sub-area.

In a display device according to one embodiment of the present disclosure, the sensor reflective plate may contact the second surface of the prism. The second surface of the prism may be exposed in a region where the plurality of reflective patterns is not disposed in the pattern portion of the sensor reflective plate.

In a display device according to one embodiment of the present disclosure, the second surface of the prism of the optical module may overlap with the second area of the display panel.

In a display device according to one embodiment of the present disclosure, the prism may have a triangular pillar shape having a longitudinal direction at the first surface. The prism may comprise the first surface and the second surface contiguous with each other, a third surface inclined from and contiguous with each of the first and second surfaces, and a fourth surface and a fifth surface facing each other and surrounded by the first, second, and third surfaces, respectively. The first surface may have a larger area than the first area and the second surface may have a larger area than the first sub-area of the first area.

In a display device according to one embodiment of the present disclosure, the optical module may further comprise an opposite reflective plate disposed at the third surface of the prism, and an auxiliary light source disposed on at least one of the fourth surface and the fifth surface.

In a display device according to one embodiment of the present disclosure, an external light may pass through the display panel and the prism and may be then received by the sensor member a via vertical light directed toward the opposite reflective plate and a horizontal light directed from the opposite reflective plate toward the pattern portion of the sensor reflective plate.

In a display device according to one embodiment of the present disclosure, when the sensor member senses external light, the vertical light passes through subpixels of the display panel in a white state and the prism, and the horizontal light passes through the prism and a region where the plurality of reflective patterns is not disposed in the pattern portion of the sensor reflective plate.

In a display device according to one embodiment of the present disclosure, the display panel may comprise a first substrate, and a plurality of gate lines and a plurality of data lines disposed in an active area of the first substrate and crossing each other to define subpixels. The first area of the display panel may comprise a first sub-area corresponding to a size of the pattern portion of the sensor reflective plate, and a second sub-area surrounding the first sub-area. The plurality of data lines may be arranged at a first pitch in the second area of the display panel, and the first area comprises an area where the plurality of data lines is arranged at a second pitch greater than the first pitch.

In a display device according to one embodiment of the present disclosure, the first area may comprise a first subpixel group where the plurality of data lines is arranged at the first pitch, and a second subpixel group where the plurality of data lines is arranged at the second pitch.

In a display device according to one embodiment of the present disclosure, the first sub-area and the second sub-area may comprise the second subpixel group in a same manner.

In a display device according to one embodiment of the present disclosure, the first subpixel group and the second subpixel group may be alternately arranged in at least one of a row direction and a column direction.

In a display device according to one embodiment of the present disclosure, during sensing of external light, the second subpixel group in the first sub-area represents a white state.

In a display device according to one embodiment of the present disclosure, the display panel may further comprise a second substrate facing the first substrate, and a color filter overlapping with the first pitch among the plurality of data lines in an active area of the second substrate and a liquid crystal layer filled between the first substrate and the second substrate and the color filter is not disposed among the data lines spaced apart from one another by the second pitch.

In a display device according to one embodiment of the present disclosure, the display panel may comprise a liquid crystal panel, and a backlight unit may be further disposed between the display panel and the optical module. The backlight unit may comprise an optical sheet, a light guide plate, and a reflective plate sequentially arranged from a side closer to the display panel to a side farther from the display panel, and a light source disposed on at least one side of the light guide plate, the optical sheet comprises an optical sheet hole larger than the first area and the reflective plate comprises a reflective plate hole having a size corresponding to the first area.

In a display device according to one embodiment of the present disclosure, the sensor reflective plate may comprise a first reflective material around the pattern portion, and the plurality of reflective patterns in the pattern portion comprises the first reflective material.

A driving method for display device according to one embodiment of the present may comprise performing a display mode through the display panel and performing an external-light sensing mode through the optical module during a non-display mode. The external-light sensing mode may be performed in the sensor member under a condition that external light introduced from above the display panel is refracted in the prism, and is then transmitted through the pattern portion of the sensor reflective plate.

In the display panel, the first area has a smaller subpixel arrangement density than the second area, and the first area comprises a first sub-area disposed at a center of the first area, the first sub-area having a size corresponding to the pattern portion of the sensor reflective plate, and a second sub-area surrounding the first sub-area. In the display mode of the display panel, a luminance supplied to the first sub-area may be higher than a luminance supplied to the second sub-area.

Although the preferred embodiments of the present disclosure have been disclosed for illustrative purposes, those skilled in the art will appreciate that various modifications, additions and substitutions are possible, without departing from the scope and technical idea of the disclosure as disclosed in the accompanying claims.

What is claimed is:

1. A display device comprising:
a display panel comprising an active area and a non-active area, the active area comprising a first area and a second area with different subpixel arrangement densities, and the non-active area disposed outside the active area; and
an optical module comprising:
a prism disposed under the display panel, the prism comprising a first surface parallel to a lower surface of the first area of the display panel and a second surface perpendicular to the first surface,
a sensor reflective plate disposed at the second surface of the prism, the sensor reflective plate comprising, in a region of the sensor reflective plate, a pattern portion having a plurality of reflective patterns spaced each other, and
a sensor member configured to receive external light through the pattern portion of the sensor reflective plate.

2. The display device according to claim 1, wherein the pattern portion of the sensor reflective plate has a transmission portion, the transmission portion having an area corresponding to 1/2 or more of a total area of the pattern portion.

3. The display device according to claim 1, wherein:
in the display panel, the first area has a smaller subpixel arrangement density than the second area;
the first area comprises a first sub-area and a second sub-area, the first sub-area disposed at a center of the first area, the first sub-area corresponding to the pattern portion of the sensor reflective plate, and the second sub-area surrounding the first sub-area; and
the pattern portion of the sensor reflective plate comprises a plurality of reflective patterns corresponding to color filters of subpixels disposed in the first sub-area of the display panel.

4. The display device according to claim 3, wherein subpixels of the second sub-area have a higher luminance than the subpixels of the first sub-area.

5. The display device according to claim 3, wherein:
the sensor reflective plate contacts the second surface of the prism; and
the second surface of the prism is exposed in a region where the plurality of reflective patterns is not disposed in the pattern portion of the sensor reflective plate.

6. The display device according to claim 1, wherein the second surface of the prism of the optical module overlaps with the second area of the display panel.

7. The display device according to claim 3, wherein:
the prism has a triangular pillar shape having a longitudinal direction at the first surface;
the prism comprises the first surface, the second surface, a third surface, a fourth surface and a fifth surface, the first surface and the second surface contiguous with each other, the third surface inclined from and contiguous with each of the first surface and the second surface, and the fourth surface and the fifth surface facing each other and surrounded by the first, second, and third surfaces, respectively;
the first surface has a larger area than the first area; and
the second surface has a larger area than the first sub-area of the first area.

8. The display device according to claim 7, wherein the optical module further comprises an opposite reflective plate and an auxiliary light source, the opposite reflective plate disposed at the third surface of the prism, and the auxiliary light source disposed on at least one of the fourth surface and the fifth surface.

9. The display device according to claim 8, wherein an external light passes through the display panel and the prism and the external light is then received by the sensor member via a vertical light directed toward the opposite reflective plate and a horizontal light directed from the opposite reflective plate toward the pattern portion of the sensor reflective plate.

10. The display device according to claim 9, wherein, when the sensor member senses external light, the vertical light passes through subpixels of the display panel in a white state and the prism, and the horizontal light passes through the prism and a region where the plurality of reflective patterns is not disposed in the pattern portion of the sensor reflective plate.

11. The display device according to claim 1, wherein:
the display panel comprises a first substrate, a plurality of gate lines and a plurality of data lines, and the plurality of gate lines and the plurality of data lines disposed in an active area of the first substrate and crossing each other to define subpixels;
the first area of the display panel comprises a first sub-area and a second sub-area, the first sub-area corresponding to the pattern portion of the sensor reflective plate, and the second sub-area surrounding the first sub-area; and
the plurality of data lines is arranged at a first pitch in the second area of the display panel, and the first area comprises an area where the plurality of data lines is arranged at a second pitch greater than the first pitch.

12. The display device according to claim 11, wherein the first area comprises a first subpixel group where the plurality of data lines is arranged at the first pitch, and a second subpixel group where the plurality of data lines is arranged at the second pitch.

13. The display device according to claim 12, wherein the first sub-area and the second sub-area comprise the second subpixel group.

14. The display device according to claim 12, wherein the first subpixel group and the second subpixel group are alternately arranged in at least one of a row direction and a column direction.

15. The display device according to claim 12, wherein, during sensing of external light, the second subpixel group in the first sub-area represents a white state.

16. The display device according to claim 11, wherein:
the display panel further comprises:
a second substrate facing the first substrate, and a color filter overlapping with the first pitch among the plurality of data lines in an active area of the second substrate; and
a liquid crystal layer filled between the first substrate and the second substrate; and
the color filter is not disposed among the plurality of data lines spaced apart from one another by the second pitch.

17. The display device according to claim 1, wherein:
the display panel comprises a liquid crystal panel;
a backlight unit is disposed between the display panel and the optical module;
the backlight unit comprises a light source, an optical sheet, a light guide plate, and a reflective plate, the optical sheet, the light guide plate, and the reflective plate sequentially arranged from a side closer to the display panel to a side farther from the display panel, and the light source disposed on at least one side of the light guide plate;
the optical sheet comprises an optical sheet hole larger than the first area; and
the reflective plate comprises a reflective plate hole having a size corresponding to the first area.

18. The display device according to claim 1, wherein:
the sensor reflective plate comprises a first reflective material around the pattern portion, and
the plurality of reflective patterns in the pattern portion comprises the first reflective material.

19. A driving method for the display device according to claim 1 comprising:
performing a display mode through the display panel; and
performing an external-light sensing mode through the optical module during a non-display mode,
wherein the external-light sensing mode is performed in the sensor member under a condition that external light introduced from above the display panel is refracted in the prism, and the external light is then transmitted through the pattern portion of the sensor reflective plate.

20. The driving method according to claim 19, wherein:
in the display panel, the first area has a smaller subpixel arrangement density than the second area, and the first area comprises a first sub-area disposed at a center of the first area, the first sub-area having a size corresponding to the pattern portion of the sensor reflective plate, and a second sub-area surrounding the first sub-area; and
in the display mode of the display panel, a luminance supplied to the first sub-area is higher than a luminance supplied to the second sub-area.
